(19) United States
(12) Patent Application Publication
(10) Pub. No.: US 2026/0324719 A1
(43) Pub. Date: Oct. 22, 2026

(54) AEROSOL PROVISION DEVICE

(71) Applicant: Nicoventures Trading Limited, London (GB)

(72) Inventors: Jiajia FU, Shenzhen (CN); Min XU, Shenzhen (CN)

(21) Appl. No.: 19/491,088

(22) PCT Filed: Jun. 6, 2024
(86) PCT No.: PCT/EP2024/065656

§ 371 Date: Dec. 8, 2025

(30) Foreign Application Priority Data
Jun. 9, 2023 (CN) 2023106870163
Jul. 4, 2023 (GB) 2310248.6

(51) Int. Cl. A24F 40/40; A24F 40/20; F21K 9/237; F21K 9/68; F21V 19/00; F21Y 115/10

(52) U.S. Cl. CPC A24F 40/40; F21K 9/237; F21K 9/68; F21V 19/0015; A24F 40/20; F21Y 2115/10

(57) ABSTRACT

An aerosol provision device that includes a display apparatus, the display apparatus comprising: a light source; a first reflector configured to at least partially reflect light from the light source; and a second reflector configured to at least partially reflect light from the first reflector to illuminate the display apparatus.

### CROSS-REFERENCE TO RELATED APPLICATIONS

This present application is a National Phase entry of PCT Application No. PCT/EP2024/065656, filed Jun. 6, 2024, which claims priority from Chinese Application No. 2023106870163, filed Jun. 9, 2023, and which claims priority from Great Britain Application No. 2310248.6, filed Jul. 4, 2023, each of which are fully incorporated herein by reference in their entireties.

### TECHNICAL FIELD

The present invention relates to an aerosol provision device and a method.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with the first aspect, there is provided an aerosol provision device comprising a display apparatus, the display apparatus comprising: a light source; a first reflector configured to at least partially reflect light from the light source; and a second reflector configured to at least partially reflect light from the first reflector to illuminate the display apparatus.

The second reflector may be configured to reflect light from the first reflector back to the first reflector, the first reflector configured to at least partially transmit the light to illuminate the display apparatus.

The first reflector may comprises a reflection region and a transmission region, wherein the light source is configured to transmit light to the reflection region and the second reflector is configured to reflect light from the first reflector to the transmission region.

The transmission region may be configured to transmit a greater proportion of incident light than the reflection region.

The transmission region may be positioned adjacent to the reflection region.

The transmission region may comprise an aperture.

The aerosol provision device may comprise an additional transmission region.

The first reflector may comprise a reflective coating.

The first reflector is formed of a plastic material.

The plastic material may be PET.

The second reflector may be comprised in a printed circuit board.

The second reflector may comprise a reflective coating on the printed circuit board.

The printed circuit board may support the light source.

The first and second reflectors may be substantially parallel to each other.

The aerosol provision device may comprise a housing.

The housing may comprise an aperture, wherein the display apparatus is at least partially located at the aperture.

According to a second aspect there is provided an aerosol provision system comprising the aerosol provision device and an article comprising aerosol generating material.

According to a third aspect there is provided a method of providing a display from an aerosol provision device, the method comprising: transmitting light from a light source; reflecting the light from a first reflector; and reflecting the light from a second reflector to illuminate the display apparatus.

### BRIEF DESCRIPTION OF DRAWINGS

Embodiments will now be described, by way of example only, and with reference to the accompanying drawings in which:

FIG. 1 shows a front view of an aerosol provision system;

FIG. 2 shows a section of a display apparatus; and

FIG. 3 shows a front view of the display apparatus.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50wt %, 60wt % or 70wt % of amorphous solid, to about 90wt %, 95wt% or 100wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

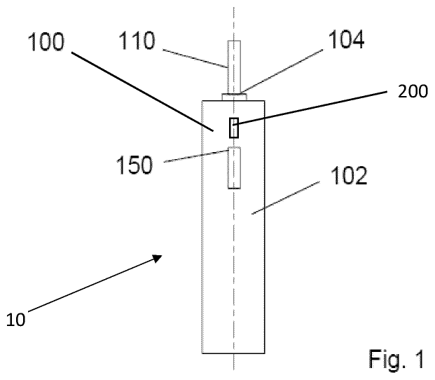

With reference to FIG. 1, an aerosol provision system 10 comprises an aerosol provision device 100 for generating aerosol from an aerosol generating material. The aerosol provision system 10 further comprises a replaceable article 110 comprising the aerosol generating material. In broad outline, the aerosol forming device 100 may be used to heat the article 110 to generate an aerosol or other inhalable medium, which is inhaled by a user of the device 100.

The aerosol forming device 100 comprises a body 102. A housing arrangement surrounds and houses various components of the body 102. An article aperture 104 is formed at one end of the body 102, through which the article 110 may be inserted for heating by an aerosol generator 116.

The device 100 may also include a user-operable control element 150, such as a button or switch, which operates the device 100 when pressed. For example, a user may turn on the device 100 by operating the switch 150.

The aerosol generator 116 defines a longitudinal axis, which aligns with an axis of the article 110.

The aerosol forming device 100 comprises a display apparatus 200.

In use, the article 110 may be fully or partially inserted into the aerosol generator 116 where it may be heated by one or more components of the aerosol generator 116.

The device 100 includes an apparatus for heating aerosol-generating material. The apparatus includes an aerosol generating assembly, a controller (control circuit), and a power source. The apparatus forms part of the body 102. The aerosol generating assembly is configured to heat the aerosol-generating material of an article 110 inserted through the article aperture 104, such that an aerosol is generated from the aerosol generating material. The power source supplies electrical power to the aerosol generating assembly, and the aerosol generating assembly converts the supplied electrical energy into heat energy for heating the aerosol-generating material. The power source may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source may be electrically coupled to the aerosol generating assembly to supply electrical power when required and under control of the controller to heat the aerosol generating material. The control circuit may be configured to activate and deactivate the aerosol generating assembly based on a user input. The user input may be via a button press or opening a door of the device (for example, a door covering a consumable receiving receptacle). The control circuit may be configured to activate and deactivate automatically, for example on insertion of an article.

The aerosol generating assembly may comprise various components to heat the aerosol generating material via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The display apparatus 200 displays a light signal indicating a status (e.g. a charge status, a heating status) and/or providing a notification (e.g. a ready to use notification, and end of session notification) to the user.

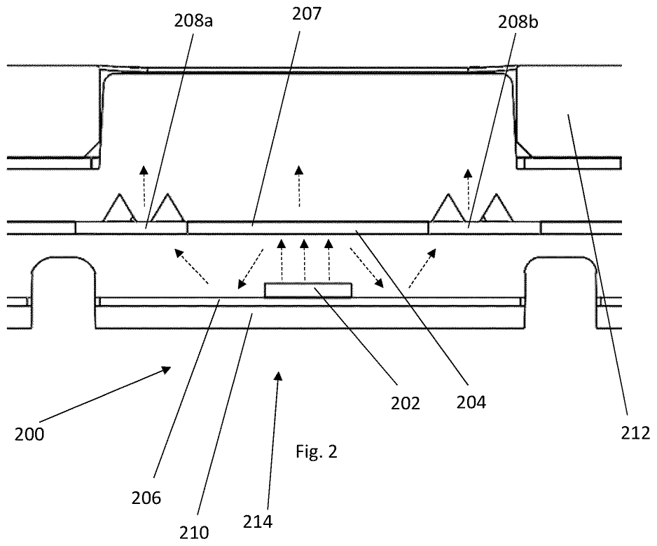

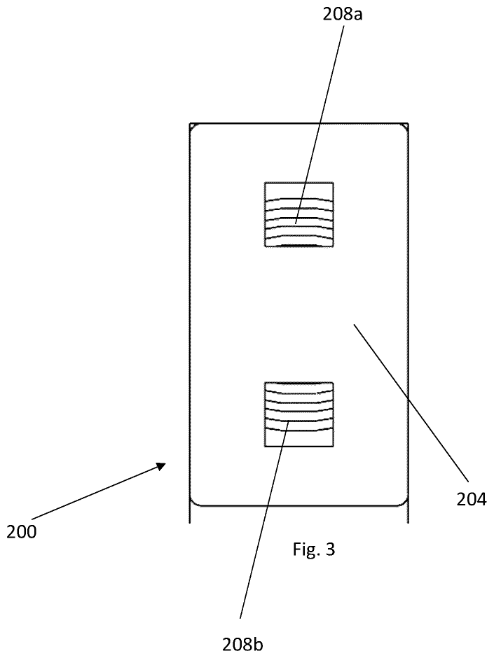

With reference to FIG. 2 and FIG. 3, the display apparatus 200 comprises a light source 202. The light source 202 is a light emitting diode (LED). The light source 202 faces outwardly from the aerosol provision device 100. The light source 202 is configured to transmit light outwardly from the aerosol provision device 100. The light source 202 is configured to transmit light in a direction substantially normal to a housing 212 of the aerosol provision device 100.

The display apparatus 200 comprises a first reflector 204. The display apparatus 200 comprises a second reflector 206. The first reflector 204 comprises a reflection region 207 and a transmission region 208a 208b. The transmission region 208a 208b comprises a first transmission region 208a and a second transmission region 208b (also referred to as an additional transmission region). The first transmission region 208a comprises a first aperture 208a. The second transmission region 208b comprises a second aperture 208b.

The reflection region 207 is positioned outwardly of the light source 202. The reflection region 207 and the light source 202 are aligned with each other, such that the light source 202 is configured to transmit light directly to the reflection region 207. The first transmission region 208a is displaced from the reflection region in a first direction. The first direction is parallel to a direction in which a housing 212 of the aerosol provision device extends. The second transmission region 208b is displaced from the reflection region in a second direction. The second direction is parallel to a direction in which a housing 212 of the aerosol provision device extends. The second direction opposes the first direction. The first transmission region 208a and the second transmission region 208b are an opposing sides of the reflection region 207.

The transmission region 208a 208b is configured to transmit a greater proportion of incident light than the reflection region 207. The transmission region 208a 208b is configured to permit light to travel through it more easily than the reflection region 207. The reflection region 207 is configured to reflect more light than the transmission region 208a 208b.

The first reflector 204 is formed of a translucent material. In the present example, the first reflector 204 is formed of plastic, more specifically polyethylene terephthalate (PET). The first transmission region 208a comprises at least one aperture to increase light transmission. The second transmission region 208b comprises at least one aperture to increase light transmission.

The first reflector 204 is substantially planar. The second reflector 206 is substantially planar. The first reflector 204 is substantially parallel to the second reflector 206. The first reflector 204 is substantially normal to the direction in which the light source 202 is configured to transmit light. The first reflector 204 is substantially parallel to the housing 212. The second reflector 206 is substantially normal to the direction in which the light source 202 is configured to transmit light. The second reflector 206 is substantially parallel to the housing 212.

The display apparatus 200 comprises a printed circuit board (PCB) 210. The light source 202 is mounted on the PCB 210. The PCB 210 supports the light source 202. The second reflector 206 forms part of the PCB 210. The second reflector 206 comprises a reflective coating on the PCB 210. The PCB 210 is configured to supply power to the light source 202.

The housing 212 contains components of the aerosol provision device 100. The housing 212 comprises a housing aperture 214. The display apparatus 200 is located at the housing aperture 214. The display apparatus 200 is mounted in the housing aperture 214, such that the display apparatus 200 extends through the housing aperture 214.

In use, (e.g. when a user notification or status update is required) the light source 202 transmits light outwardly from the housing 212, as shown by the dashed lines in FIG. 2. The light travels to the first reflector 204. More specifically, the light from the light source 202 travels primarily to the reflection region 207. Some of the light is transmitted by the reflection region 207, which causes the reflection region 207 to appear illuminated to the user.

A portion of the light is reflected by the reflection region 207. The light reflected by the reflection region 207 travels inwardly. The light reflected by the reflection region 207 travels towards the second reflector 206. The second reflector 206 reflects the light back to the first reflector 204.

As the light travels between the first and second reflectors 204 206, the light does not travel precisely perpendicularly to the first reflector 204 and/or the second reflector 206 (e.g. because the light from the light source 204 is not all contained in a beam of light, some of the light diffuses when reflected, and/or the first and/or second reflectors 204 206 are not precisely perpendicular to the direction of travel of light from the light source 204). This causes light to travel towards the transmission region 208a 208b, with some light travelling towards the first transmission region 208a in the first direction and some towards the second transmission region 208b in the second direction.

It will be understood that in some examples light may be reflected between the first and second reflectors 204 206 multiple times, with some light being transmitted with each reflection from the first reflector 204. Some light reflected from the second reflected the second reflector 206 reaches the transmission region 208a 208b, with light being transmitted from the transmission region 208a 208b. Some light may also be reflected by the transmission region 208a 208b.

Light is incident upon the first reflector 204 across the first reflector 204, with the first reflector 204 transmitting some light at each point. This causes the display apparatus 200 to appear illuminated across the first reflector 204.

In the above described embodiments, the aerosol provision device comprises a heating arrangement that is an inductive heating arrangement. In embodiments, other types of heating arrangement are used, such as resistive heating. The configuration of the device is generally as described above and so a detailed description will be omitted. In such arrangements the aerosol generating assembly comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising a display apparatus, the display apparatus comprising:
a light source;
a first reflector configured to at least partially reflect light from the light source; and
a second reflector configured to at least partially reflect light from the first reflector to illuminate the display apparatus.

2. The aerosol provision device according to claim 1, wherein the second reflector is configured to reflect light from the first reflector back to the first reflector, the first reflector configured to at least partially transmit the light to illuminate the display apparatus.

3. The aerosol provision device according to claim 2, wherein the first reflector comprises a reflection region and a transmission region, wherein the light source is configured to transmit light to the reflection region and the second reflector is configured to reflect light from the first reflector to the transmission region.

4. The aerosol provision device according to claim 3, wherein the transmission region is configured to transmit a greater proportion of incident light than the reflection region.

5. The aerosol provision device according to claim 3, wherein the transmission region is positioned adjacent to the reflection region.

6. The aerosol provision device according to claim 3, wherein the transmission region comprises an aperture.

7. The aerosol provision device according to claim 3, comprising an additional transmission region.

8. The aerosol provision device according to claim 1, wherein the first reflector comprises a reflective coating.

9. The aerosol provision device according to any of claim 1, wherein the first reflector is formed of a plastic material, optionally wherein the first reflector is formed of PET.

10. The aerosol provision device according to any of claim 1, wherein the second reflector is comprised in a printed circuit board.

11. The aerosol provision device according to claim 10, wherein the second reflector comprises a reflective coating on the printed circuit board.

12. The aerosol provision device according to claim 10, wherein the printed circuit board supports the light source.

13. The aerosol provision device according to any of claim 1, wherein the first and second reflectors are substantially parallel to each other.

14. The aerosol provision device according to claim 1 and comprising a housing, wherein the housing comprises a housing aperture, wherein the display apparatus is at least partially located at the housing aperture.

15. An aerosol provision system comprising the aerosol provision device according to claim 1 and an article comprising aerosol generating material.

16. A method of providing a display from an aerosol provision device, the method comprising:
transmitting light from a light source;
reflecting the light from a first reflector; and
reflecting the light from a second reflector to illuminate the display apparatus.
